(19) United States
(12) Patent Application Publication
(10) Pub. No.: US 2016/0012548 A1
(43) Pub. Date: Jan. 14, 2016

(54) AUTOMATED ACCOUNTING SYSTEM AND METHOD THEREOF

(71) Applicant: UNIMICRON TECHNOLOGY CORP., TAOYUAN HSIEN (TW)

(72) Inventor: CHENG-MING WENG, NEW TAIPEI CITY (TW)

(21) Appl. No.: 14/330,035

(22) Filed: Jul. 14, 2014

(51) Int. Cl. G06Q 40/00; G06Q 20/20; G07G 1/14

(52) U.S. Cl. CPC G06Q 40/12; G07G 1/14; G06Q 20/202

(57) ABSTRACT

An exemplary embodiment of the present disclosure illustrates a method of automatically accounting. The method includes steps described as follows: a user device receives a plurality of purchase signals, and the user device operates an application to generate a user interface, wherein the user interface provides an account selection window according to the purchase signals received, and the account selection window provides a plurality of personal accounts for a user to select at least one personal account so as to view a plurality of purchase records of the at least one personal account selected.

### BACKGROUND

1. Technical Field

The present disclosure relates to a system and method for automatic accounting, in particular, to a system and method for automatically receiving purchase signals to correspondingly generate purchase records.

2. Description of Related Art

Some people have the good habit of keeping accounting records to control and track their expenses. However, the common accounting tools used by them are pen and paper materials. It wastes a lot of time and paper for people to write down the cost of every purchased item in notebooks. Sometimes, people cannot write down all the items purchased because they have forgotten what goods they have bought or how much they paid. This process is laborious and error-prone.

Therefore, in recent years, various accounting applications (apps) have been developed, the mobile phone with an accounting application installed provides many functions for people to quickly input purchase records instead of writing. However, even if people don't need to write purchase details on the paper, they still have to manually input every purchased item. So, the risk of forgetting some goods they have bought still exists.

In summary, the prior art does not provide people with purchase records that include an automatically accounting service.

### SUMMARY

An exemplary embodiment of the present disclosure provides a method of automatic accounting, and the method includes steps described as follows. At least one POS terminal device generates the purchase signals. The at least one POS terminal device transmits the purchase signals to a server or the user device according to a personal identity code, wherein, if the at least one POS terminal device transmits the purchase signals to the server, the server transmits the purchase signals to the user device after the user device establishes a network connection with the server. A user device receives a plurality of purchase signals. The user device operates an application to generate a user interface, and the user interface provides an account selection window according to the purchase signals received. The account selection window provides a plurality of first personal accounts for a user to select at least one first personal account so as to view a plurality of first purchase records of the at least one first personal account.

According to one exemplary embodiment of the present disclosure, the first purchase record includes a total cost of the at least one first personal account during a selected period, wherein when the total cost exceeds an upper purchase limit, the user device correspondingly generates a warning signal to remind the user.

According to one exemplary embodiment of the present disclosure, the user interface provides a first icon for user to manually set the value of the upper purchase limit.

According to one exemplary embodiment of the present disclosure, wherein the user interface further provides a second icon, the second icon is provided for the user to delete one of the first purchase records or add a second purchase record, wherein the display mode of the second purchase record in the user interface is different to the first purchase records.

According to one exemplary embodiment of the present disclosure, wherein the user interface further provides a third icon, the third icon is provided for user to delete one of the at least one first personal accounts or add a second personal account, wherein the display mode of the second personal account in the user interface is different from the at least one first personal accounts.

According to one exemplary embodiment of the present disclosure, wherein the user interface provides a first icon for the user to manually set the value of a purchase limit, when the cost of an item purchased by the at least one first personal account exceeds the purchase limit, the user device correspondingly generates a warning signal to remind the user.

Another exemplary embodiment of the present disclosure provides an automated accounting system. The automated accounting system includes at least one POS terminal device and a user device. The at least one POS terminal device is used for generating a plurality of purchase signals. The user device is used for executing an application and receiving the purchase signals so as to display a user interface, wherein the application is installed in the user device. The user interface provides an account selection window according to the purchase signals received, and the account selection window provides a plurality of first personal accounts for a user to select at least one first personal account so as to view a plurality of first purchase records of the at least first one personal account.

Another exemplary embodiment of the present disclosure provides a method of automatic accounting, and the method includes steps described as follows. A user device receives a purchase result. The user device operates an application to generate a user interface, and the user interface provides an account selection window according to the purchase result received. The account selection window provides a plurality of first personal accounts for a user to select at least one first personal account so as to view a plurality of first purchase records of the at least one first personal account.

Another exemplary embodiment of the present disclosure provides an automated accounting system. The automated accounting system includes at least one POS terminal device, a server, and a user device. The at least one POS terminal device is used for generating a plurality of purchase signals. The server is used for receiving the purchase signals and generating a purchase result. The user device is used for executing an application and receiving the purchase result to display a user interface, wherein the application is installed in the user device. The user interface provides an account selection window according to the purchase result received, and the account selection window provides a plurality of first personal accounts for a user to select at least one first personal account so as to view a plurality of first purchase records of the at least one first personal account.

To sum up, the present disclosure provides a system and method for automatic accounting. When the user device executes the application, the user device correspondingly provides the user interface for the user to select a personal account so as to view purchase details of the personal account selected. Further, once the total cost of one personal account exceeds an upper purchase limit, the user device correspondingly generates a warning signal to remind the user. Consequently, the system and method for automatic accounting disclosed in the present disclosure can be applied to monitor the current expense of every member in a family or company.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention that they be used to limit the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a structure diagram of an automated accounting system provided in accordance with an exemplary embodiment of the present disclosure.

FIG. 2 is a flowchart diagram illustrating an automated accounting method provided in accordance with an exemplary embodiment of the present disclosure.

FIG. 3A is a diagram illustrating the user interface for reporting purchase records of one personal account provided in accordance with an exemplary embodiment of the present disclosure.

FIG. 3B is a diagram illustrating the user interface for reporting purchase details in one store provided in accordance with an exemplary embodiment of the present disclosure.

FIG. 4 is a diagram illustrating a user interface displayed for selecting at least one personal account provided in accordance with another exemplary embodiment of the present disclosure.

FIG. 5 is a diagram illustrating the user interface for reporting total costs of the selected personal accounts provided in accordance with another exemplary embodiment of the present disclosure.

FIG. 6 is a diagram illustrating the user interface for reporting purchase records of one personal account provided in accordance with another exemplary embodiment of the present disclosure.

FIG. 7 is a flowchart diagram illustrating an automated accounting method provided in accordance with another exemplary embodiment of the present disclosure.

FIG. 8 is a flowchart diagram illustrating an automated accounting method provided in accordance with another exemplary embodiment of the present disclosure.

### DESCRIPTION OF THE EXEMPLARY EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It should be understood that the usage of “first”, “second” and “third” intends to distinguish one element from another, and the element should not be limited by the term. Therefore, hereinafter a first element is interchangeable with a second element. The term “and/or” includes one and one or more of the combination in the group as described.

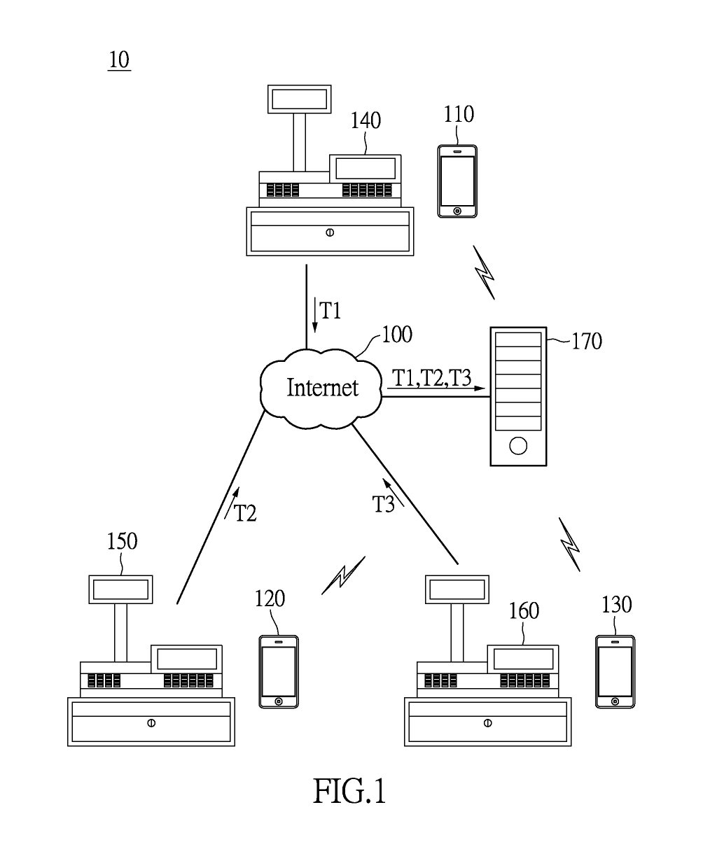

Please refer to FIG. 1. FIG. 1 is a structure diagram of an automated accounting system provided in accordance to an exemplary embodiment of the present disclosure. The automated accounting system 10 includes an Internet 100, a plurality of user devices 110˜130, a plurality of Point-of-sale (POS) terminal devices 140˜160, and a server 170.

As shown in FIG. 1, the user devices 110˜130 are smart phones, but the user devices 110˜130 may be laptop, desktop, or any electronic device capable of internet communication, and the instant embodiment is not limited thereto. The POS terminal devices 140˜160 are connected to the server 170 through the Internet 100. The user devices 110˜130 are connected to the server 170 through a base station (not shown) or a router (not shown). Preferably, the user devices 110˜130 need to transmit a password and an ID number to the server 170 through a base station or a router so as to establish connection with the server 170.

It is worth noting that the exact number of user devices and POS terminal devices is not limited in the instant disclosure. The user devices 110˜130 and the POS terminal devices 140˜160 are used for exemplary purposes only.

In the instant embodiment, each of the POS terminal devices 140˜160 is used for generating a purchase signal in response to the user's consumption (e.g. the users of the user device 110, 120, or 130 buy some goods in a convenience store, a department store, or a clothing store) and transmitting the purchase signal generated to the server 170 through the Internet 100. Each of the user devices 110˜130 is used for executing an application (app) and receiving the purchase signal transmitted by the server 170 so as to automatically generate a user interface for showing purchase records (e.g. purchase date and time, purchased item, pay by cash, credit card, or check, or purchased items price) according to the purchase signal received, wherein the application is previously installed in the user devices 110˜130.

More specifically, each of the POS terminal devices 140˜160 is also used for receiving a personal identity code. Each of the POS terminal devices 140˜160 includes a memory unit (not shown), and a database with a plurality of member identification (ID) codes have been stored in the memory unit previously. Each member ID code in the database corresponds to a personal identity code, so that the POS terminal devices 140˜160 can ensure the membership of the user of the user devices 110˜130 by searching for a member ID code from the datasheet according to the personal identity code received. In the instant embodiment, the personal identity code is a mobile barcode, ID card number, email, phone number, or identity data stored in the RFID tag or chip card. Further, the personal identity code may also by other types of verification code, and the instant disclosure is not limited thereto.

After the POS terminal device 140, 150, or 160 ensures the membership of the user of the user device 110, 120, or 130 according to the personal identity code received, the POS terminal device 140, 150, or 160 transmits a purchase signal (e.g. signal T1, T2, or T3) in response to the user's consumption to the server 170 through the Internet 100. After the user device 110, 120, or 130 establishes a connection with the server 170, the user device 110, 120, or 130 correspondingly receives the purchase signal (e.g. signal T1, T2, or T3) transmitted by the server 170. Therefore, the user device 110, 120, or 130 can display purchase records in response to the user's consumption according to the purchase signal received.

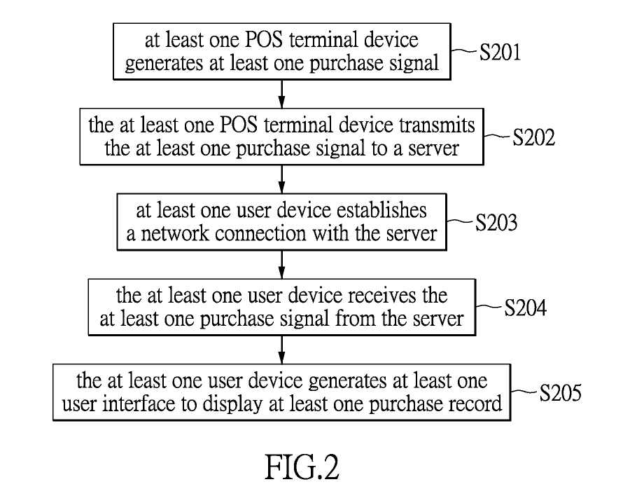

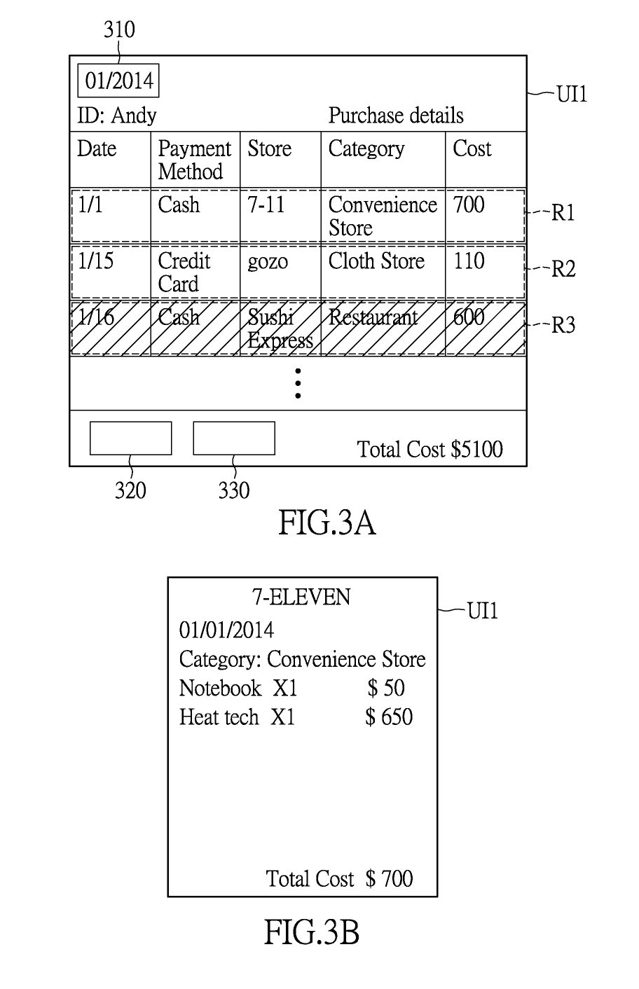

Please refer to FIG. 1, FIG. 2, and FIG. 3A. FIG. 2 is a flowchart diagram illustrating an automated accounting method provided in accordance to an exemplary embodiment of the present disclosure. FIG. 3A is a diagram illustrating the user interface for reporting purchase records of one personal account provided in accordance with an exemplary embodiment of the present disclosure. The automated accounting method is described in the following steps:

Step S201: at least one POS terminal device generates at least one purchase signal. More specifically, the POS terminal device 140 generates a purchase signal T1 according to the price and the kind of purchased items bought by the user of the user device 110 in some store (e.g. convenience store, department store, or clothing store) and payment method (e.g. pay by cash, credit card, or check) selected by the user of the user device 110. Similarly, the POS terminal device 150 generate a purchase signal T2 according to the user's consumption, and/or the POS terminal device 160 generate a purchase signal T3 according to the user's consumption.

Step S202: the at least one POS terminal device transmits the at least one purchase signal to a server. Specifically, the POS terminal device 140 transmits the purchase signal T1 to a server 170 through the Internet 100 according to a personal identity code in response to the user of the user device 110. Similarly, the POS terminal device 150 transmits the purchase signal T2 to the server 170 through the Internet 100 according to a personal identity code in response to the user of the user device 120, and/or the POS terminal device 160 transmits the purchase signal T3 to the server 170 through the Internet 100 according to a personal identity code in response to the user of the user device 130. More specifically, in the Step S202, the POS terminal device 140 as an example, the POS terminal device 140 gets the personal identity code from the user of the user device 110 and inputs the personal identity code into the POS terminal device 140 through a keyboard (if the personal identity code is an ID card number, email, or phone number), a reader (if the personal identity code is identity data stored in the RFID tag or chip card) or a barcode scanner (if the personal identity code is mobile barcode), the POS terminal device 140 correspondingly compares the personal identity code with the member ID codes from the database after reception of the personal identity code. When the POS terminal device 140 finds the matched member ID code from the database according to the personal identity code received, the POS terminal device 140 transmits a purchase signal T1 to the server 170 through the Internet 100.

Step S203: at least one user device establishes a network connection with the server. More specifically, in Step S203, using the user device 110 as an example, the user device 110 is operated by the user to execute the application installed in the internal or external memory of the user device 110, and then the user device 110 automatically transmits a password and an ID number to the server 170 through a base station or a router, wherein the password and the ID number is stored in the internal memory or external memory of the user device 110 previously. After the server 170 receives the password and the ID number transmitted by the user device 110, the server 170 compares the received password and the received ID number with a password and an ID number stored in its internal memory or external memory. If the received password and the received ID number match the password and the ID number stored in the server 170, the user device 110 establishes a network connection with the server 170.

Step S204: the at least one user device receives the at least one purchase signal from the server. More specifically, after the user device 110 establishes connection with the server 170 by executing the aforementioned Step S203, the server 170 transmits the purchase signal T1 received to the user device 110. Similarly, after the user device 120 and the user device 130 establish connection with the server 170 by executing the aforementioned Step S203, the server 170 transmits the purchase signal T2 and the purchase signal T3 received to the user device 120 and the user device 130, respectively.

Step S205: the at least one user device generates at least one user interface to display at least one purchase record according to the purchase signal received. More specifically, in the Step S205, using the user device 110 as an example, the user device 110 generates a user interface for providing the purchase record according to the purchase signal T1 received. Therefore, if the user of the user device 110 consumes in different store, the user device 110 correspondingly receives a plurality of purchase signals T1 by executing the application and then generates the user interface to display a plurality of purchase records according to the purchase signals T1 received. As shown in FIG. 3A, the user interface UI1 displays the purchase records (i.e. row R1˜R2), and the information of the purchase records includes the purchase date, payment method, store, category, and cost about purchased products or services, and even displays total cost about purchased products. In addition, it is noted that the category of the store is determined by the user device 110 according to the purchase signals T1. In detail, each purchase signal T1 has a category code that corresponds to the POS terminal device 140. The category code has been stored in the memory of the POS terminal device 140 previously, and the POS terminal device 140 correspondingly adds the category code into the purchase signal T1 when the POS terminal device 140 generates the purchase signal T1. In this way, the user devices 110˜130 can correspondingly determine the category (e.g. convenience store, traffic, restaurant, or clothing store) of different stores visited by the consumer according to the category code of the purchase signal T1.

Moreover, the user interface UI1 provides an icon 310 for the user of the user device 110 to select a period (e.g. one week, one month, or one year) so as to view the purchase records in the period selected, and the user interface UI1 provides an icon 320 for the user of the user device 110 to manually edit the context of the purchase records displayed. Specifically, the user selects the icon 320 to delete a purchase record (i.e. row R1 or row R2), or to add a new purchase record (i.e. row R3). It is noted that the display mode of the row R3 is different from the rows R1 and R2, for example, the background-color of the row R3 is darker that the rows R1 and R3, so that the user can directly understand which one row is manually added by himself/herself. The display type of the row R3 is not limited in the instant disclosure. Preferably, when the user of the user device 110 selects the icon 320, the user interface UI1 correspondingly displays a window to require the user to input a password. After the user inputs the correct password, the user can edit the context of the purchase records displayed (e.g. add a new purchase record or delete a purchase record) by selecting the icon 320.

The user interface UI1 provides an icon 330 for the user of the user device 110 to set an upper purchase limit. When total cost of all purchased item by the user of the user device 110 exceeds the upper purchase limit, the user device 110 generates a warning signal to warn the user, for example, the user device 110 correspondingly generates a window to display a sentence “total cost exceeds $5000”.

For another example, assume the upper purchase limit is $5000, the total cost (e.g. $5100) as shown in the FIG. 3A exceeds the upper purchase limit, the color of the word (e.g. $5100) displayed in the user device 110 is red or/and the font size of the word (e.g. $5100) displayed in the user device 110 is larger than the font size of other words, so as to remind the user. The display mode of the warning signal is not limited thereto.

In addition, the user of the user device 110 can further select the row R1, R2, or R3 to view purchase records in one store. For example, please refer to FIG. 3B. FIG. 3B is a diagram illustrating the user interface for reporting purchase detail in one store provided in accordance to an exemplary embodiment of the present disclosure. As shown in the FIG. 3B, when the user of the user device 110 selects the row R1, the user interface UI1 is correspondingly updated by the user device 110 to display the purchase detail (e.g. the price of the Notebook bought by user is $50, the price of the Heat tech bought by user is $650, and the total cost is $700) in 7-11.

In the instant embodiment, the icon 320 is also provided for the user of the user device 110 to set a purchase limit of every purchased item. When the cost of one purchased item exceeds the purchase limit, the user device 110 also generates a warning signal to warn the user. For example, assume the purchase limit is $600, the cost of the notebook (e.g. $650) as shown in the FIG. 3B exceeds the purchase limit, the user device 110 shows a window to warn the user or the color of the word (e.g. $650) displayed in the user device 110 is red or/and the font size of the word (e.g. $650) displayed in the user device 110 is larger than the font size of other words, so as to remind the user.

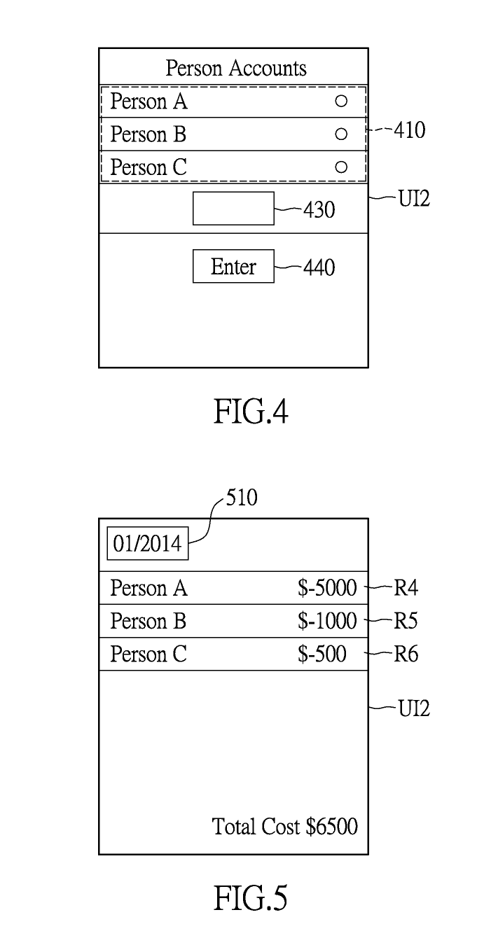

Please refer to FIG. 1, FIG. 2 and FIG. 4. FIG. 4 is a diagram illustrating a user interface displayed for selecting at least one personal account provided in accordance to another exemplary embodiment of the present disclosure. In the instant embodiment, the user device 110 can generate a user interface UI2 for the user of the user device 110 to view the purchase records in response to the user of the user device 110, 120, or 130.

In the instant embodiment, after the user device 110 transmits the password and the ID number to the server 170, the server 170 transmits the purchase signal T1, as well as the purchase signals T2 and T3 according to the password and the ID number transmitted by the user device 110.

Therefore, when the user device 110 executes the application installed in the user device 110, the user device 110 generates the user interface UI2 with the account selection window 410 according to the purchase signals T1˜T3. As shown in the FIG. 4, the account selection window 410 provides a plurality of personal accounts (e.g. person A represents the user of the user device 110, the person B represents the user of the user device 120, and person C represents the user of the user device 130) for the user of the user device 110 to select at least one personal account so as to view person A (i.e. himself/herself), person B, or person C's purchase records.

In detail, please refer to FIG. 5. FIG. 5 is a diagram illustrating the user interface for reporting total costs of the selected personal accounts provided in accordance to another exemplary embodiment of the present disclosure. If the user of the user device 110 selects all personal accounts and points enter 440 provided by the user interface UI2, the user interface UI2 will be updated by the user device 110 (as shown in FIG. 5) to display the total costs corresponding to the person A, person B, and person C during the current month, respectively. Further, the user interface UI2 provides an icon 510 for the user of the user device 110 to select a period so as to view the total costs corresponding to person A, person B, and person C in the selected period, respectively. Moreover, the user of the user device 110 can further select the row R4, R5, or R6 to view the purchase records corresponding to the person A, person B, and person C's consumption, respectively.

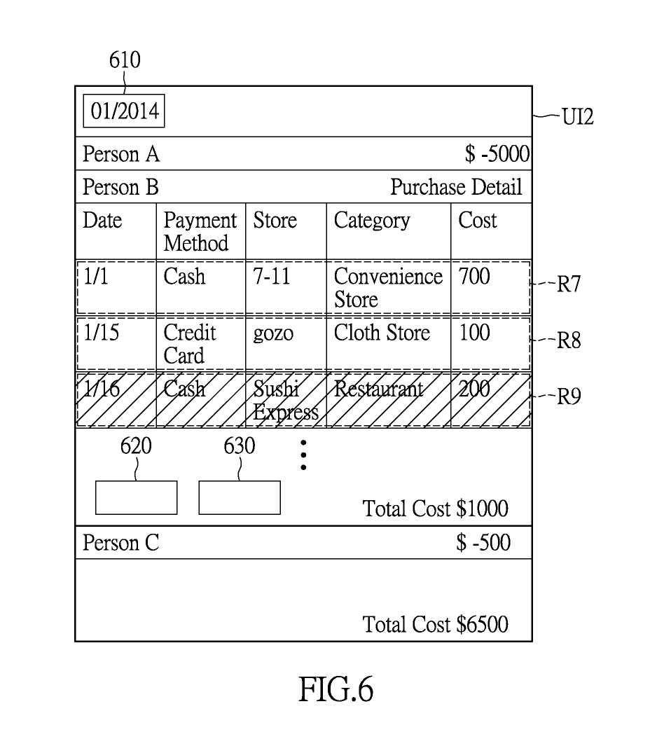

For example, please refer to FIG. 6. FIG. 6 is a diagram illustrating the user interface for reporting purchase records of one personal account provided in accordance to another exemplary embodiment of the present disclosure. As shown in FIG. 6, when the user of the user device 110 selects the row R5 corresponding to the person B (i.e. the user of the user device 120), the user interface UI2 is correspondingly updated by the user device 110 to display the purchase records in response to the person B according to the purchase signal T2, wherein the purchase records include the purchase date, payment method, store, category, and cost of purchased products or services.

Moreover, the icon 610 is similar to the icon 310 which is provided for the user of the user device 110 to select a period so as to view the purchase records corresponding to the person B in the period selected, and the icon 620 is similar to the icon 320 which is provided for the user to manually delete the row R7 or the row R8, or to manually add the row R9. Similarly, the user device 110 can further select the row R7 to view the purchase records (e.g. purchased items) in 7-11, select the row R8 to view the purchase records in GOZO, or select the row R9 to view the purchase records in Sushi Express, referring to the instant embodiment in FIG. 3B. In addition, the icon 630 is similar to the icon 330 which is provided for the user of the user device 110 to set an upper purchase limit or a purchase limit. In this way, when the total cost of the person B exceeds the upper purchase limit during the selected period, the user device 110 automatically generates a warning signal to remind the user of the user device 110 that the expenses of the person B has exceeded a predetermined value. When the cost of an item purchased by the person B exceeds the purchase limit, the user device 110 generates a warning signal to remind the user of the user device 110. In the instant embodiment, the user interface UI2 as shown in the FIG. 4 further includes another icon, the icon is provided for user to quickly set the purchase limit. When the cost of an item purchased by the person A, B, or C exceeds the purchase limit, the user device 110 generates a warning signal to remind the user of the user device 110.

Specifically, please refer to FIG. 4, the icon 430 is provided for a user to add a new personal account or delete a personal account (e.g. delete person A, person B, or person C). In the instant embodiment, the display mode of the personal account in the user interface is different from the other personal accounts (e.g. delete person A, person B, and person C), for example, the background-color of the personal account added is darker than the other personal accounts (e.g. delete person A, person B, and person C).

From the aforementioned exemplary embodiment of the present disclosure, the system and method for automatic accounting disclosed in the present disclosure can be applied to monitor the current expense of every member in a family or company.

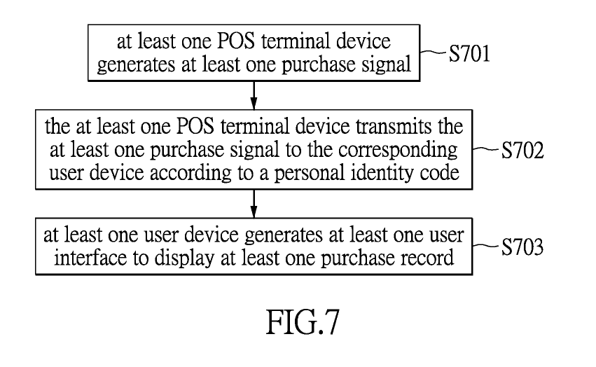

Please refer to FIG. 7. FIG. 7 is a flowchart diagram illustrating an automated accounting method provided in accordance with another exemplary embodiment of the present disclosure. The difference between the instant embodiment (FIG. 7) and the previous embodiment (FIG. 2) arises from the fact that after the POS terminal devices 140˜160 respectively generate a purchase signal in response to the user's consumption, the POS terminal devices 140˜160 directly and respectively transmit the purchase signals T1˜T3 generated to the user devices 110˜130. In the instant embodiment, the POS terminal devices 140˜160 are respectively connected to the NFC modules (not shown), or the NFC modules are respectively integrated into the POS terminal devices 140˜160, and the instant embodiment is not limited thereto. Further, the NFC modules are respectively integrated into the devices 110˜130. In this way, the POS terminal devices 140˜160 can directly communicate with the user devices 110˜130. The automated accounting method is described in the following steps:

Step S701: at least one POS terminal device generates at least one purchase signal. More specifically, the POS terminal device 140, 150, or 160 generates at least one purchase signal (e.g. purchase signal T1, T2, or T3) in response to the user's consumption (e.g. the price and the kind of purchased items bought by the user of the user device 110, 120, or 130 in some store and payment method used by the user of the user device 110, 120, or 130).

Step S702: the at least one POS terminal device transmits the at least one purchase signal to the corresponding user device according to a personal identity code. More specifically, the POS terminal device 140, 150, or 160 transmits the at least one purchase signal to the user device 110, 120, or 130. In the Step S702, using the POS terminal device 140 and the user devices 110 as an example, the POS terminal device 140 gets a personal identity code from a user of the user device 110 and inputs the personal identity code through a keyboard (if the personal identity code is an ID card number, email, or phone number), a reader (if the personal identity code is identity data stored in the chip card) or a barcode scanner (if the personal identity code is a mobile barcode), the POS terminal device 140 correspondingly compares the personal identity code with the member ID codes in the database after reception of the personal identity code. When the POS terminal device 140 finds the member ID code from the database that corresponds to the personal identity code received, the POS terminal device 140 transmits a purchase signal T1 to the user device 110 through the NFC module. In the instant embodiment, when the user device 110 is holed to approach or contact the POS terminal device 140, the user device 110 through the NFC module wirelessly transmits the personal identity code to the NFC module of the POS terminal device 140, so that the POS terminal device 140 correspondingly compares the personal identity code with the member ID codes in the database after reception of the personal identity code.

Step S703: at least one user device generates at least one user interface to display at least one purchase record. More specifically, the user device 110, 120, or 130 generates user interfaces UI1 as shown in FIG. 3A and FIG. 3B (if at least one user device receives the correspondingly purchase signal through the at least one the POS terminal device) or user interfaces UI2 as shown in FIGS. 4, 5, and 6 (if at least one user device receives all purchase signals through the at least one the POS terminal device) in order to correspondingly display a plurality of purchase records according to the purchase signals received, and then the user can select one of the purchase records to view purchase details.

Notably, similar operations of the user devices 110˜130 in the instant embodiment and the previous embodiments as shown in FIG. 3A through FIG. 6 are not repeated herein.

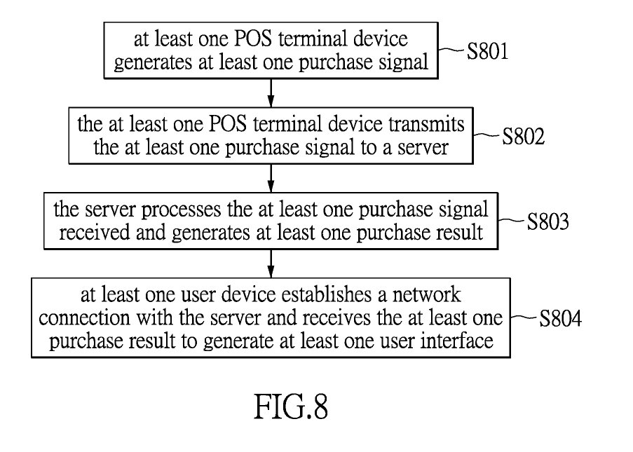

Please refer to FIG. 1, FIG. 3A˜FIG. 6, and FIG. 8. FIG. 8 is a flowchart diagram illustrating an automated accounting method provided in accordance with another exemplary embodiment of the present disclosure. The automated accounting method is described in the following steps:

Step S801: at least one POS terminal device generates at least one purchase signal. More specifically, the POS terminal device 140, 150, or 160 generates at least one purchase signal (e.g. purchase signal T1, T2, or T3) in response to the user's consumption (e.g. the price and the kind of purchased items bought by the user of the user device 110, 120, or 130 in some store and payment method used by the user of the user device 110, 120, or 130).

Step S802: the at least one POS terminal device transmits the at least one purchase signal to a server. More specifically, the POS terminal device 140, 150, or 160 transmits the at least one purchase signal to a server 170 through the Internet 100 according to personal identity codes in response to the user of the user device 110, 120, or 130.

Step S803: the server processes the at least one purchase signal received and generates at least one purchase result. More specifically, in Step S803, using the user device 110 as an example, the server 170 calculates the total cost of all items purchased by the user of the user device 110 in the predetermined period (e.g. current month or year) according to the purchase signal T1 to generate the purchase result, or the server 170 calculates the total cost of all items purchased by all users of the user devices 110˜130 in the predetermined period (e.g. current month or year) according to the purchase signals T1˜T3 to generate the purchase result.

Step S804: at least one user device establishes a network connection with the server and receives the at least one purchase result to generate at least one user interface. More specifically, in Step S804, using the user device 110 as an example, the user device 110 operates the application installed in the internal or external memory of the user device 110, and then the user device 110 automatically transmits a password and an ID number to the server 170. If the received password and the received ID number match the password and the ID number stored in the server 170, the user device 110 establishes a network connection with the server 170 and correspondingly receives the purchase result. The user device 110 generates the user interface UI1 (if the server 170 calculates the total cost according to the purchase signal T1 in the Step S803) or the user interface UI2 (if the server 170 calculates the total cost according to the purchase signals T1˜T3 in the Step S803) according to the purchase result received.

In this way, the user of the user device 110 can view own purchase records or purchase details through the user interface UI1, or the user of the user device 110 can view purchase records or purchase details of every user (i.e. users of the user devices 110˜130) through the user interface UI2.

Notably, similar operations of the user devices 110˜130 in the instant embodiment and the previous embodiments as shown in FIG. 3A through FIG. 6 are not repeated herein.

In summary, the present disclosure provides a system and method for automatic accounting. When the user device executes the application, the user device correspondingly provides the user interface for a user to select a personal account so as to view purchase details of the personal account selected. Further, once total cost of one personal account exceeds an upper purchase limit, the user device correspondingly generates a warning signal to remind the user. Consequently, the system and method for automatic accounting disclosed in the present disclosure can be applied to monitor the current expense of every member in a family or company.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method of automatically accounting, comprising:
a user device receives a plurality of purchase signals; and
the user device operates an application to generate a user interface, and the user interface provides an account selection window according to the purchase signals received;
wherein, the account selection window provides a plurality of first personal accounts for a user to select at least one first personal account so as to view a plurality of first purchase records of the at least one first personal account.

2. The method of automatically accounting according to claim 1, wherein the first purchase record includes a total cost of the at least one first personal account during a selected period, wherein when the total cost exceeds an upper purchase limit, the user device correspondingly generates a warning signal to remind the user.

3. The method of automatically accounting according to claim 2, wherein the user interface provides a first icon for the user to manually set the value of the upper purchase limit.

4. The method of automatically accounting according to claim 1, further comprising:
at least one POS terminal device generates the purchase signals; and
the at least one POS terminal device transmits the purchase signals to a server or the user device according to a personal identity code;
wherein, if the at least one POS terminal device transmits the purchase signals to the server, the server transmits the purchase signals to the user device after the user device establishes a network connection with the server.

5. The method of automatically accounting according to claim 4, wherein the personal identity code is mobile barcode, ID card number, email, phone number, or identity data stored in the RFID tag or chip card.

6. The method of automatically accounting according to claim 1, wherein the user interface further provides a second icon, the second icon is provided for the user to delete one of the first purchase records or add a second purchase record, wherein the display mode of the second purchase record in the user interface is different to the first purchase records.

7. The method of automatically accounting according to claim 1, wherein the user interface further provides a third icon, the third icon is provided for user to delete one of the at least one first personal accounts or add a second personal account, wherein the display mode of the second personal account in the user interface is different from the at least one first personal account.

8. The method of automatically accounting according to claim 1, wherein the user interface provides a first icon for the user to manually set the value of a purchase limit, when the cost of an item purchased by the at least one first personal account exceeds the purchase limit, the user device correspondingly generates a warning signal to remind the user.

9. An automated accounting system, comprising:
at least one POS terminal device, for generating a plurality of purchase signals; and
a user device, for executing an application and receiving the purchase signals to display a user interface, wherein the application is installed in the user device;
wherein, the user interface provides an account selection window according to the purchase signals received, and the account selection window provides a plurality of first personal accounts for a user to select at least one first personal account so as to view a plurality of first purchase records of the at least one first personal account.

10. The automated accounting system according to claim 9, wherein the first purchase record includes a total cost of the at least one first personal account during a selected period, wherein when the total cost exceeds an upper purchase limit, the user device correspondingly generates a warning signal to remind the user.

11. The automated accounting system as recited in claim 10, wherein the user interface provides a first icon for a user to manually set the value of the upper purchase limit.

12. The automated accounting system according to claim 9, wherein the at least one POS terminal device transmits the purchase signals to a server or the user device according to a personal identity code, wherein if the at least one POS terminal device transmits the purchase signals to the server, the server transmits the purchase signals to the user device after the user device establishes a network connection with the server.

13. The automated accounting system according to claim 12, wherein the personal identity code is a mobile barcode, ID card number, email, phone number, or identity data stored in the RFID tag or chip card.

14. The automated accounting system according to claim 9, wherein the user interface further provides a second icon, the second icon is provided for the user to delete one of the first purchase records or add a second purchase record, wherein the display mode of the second purchase record in the user interface is different from the first purchase record.

15. The automated accounting system according to claim 9, wherein the user interface further provides a third icon, the third icon is provided for the user to delete one of the at least one first personal accounts or add a second personal account, wherein the display mode of the second personal account in the user interface is different to the at least one first personal account.

16. The automated accounting system according to claim 9, wherein the user interface provides a first icon for the user to manually set the value of a purchase limit, when the cost of an item purchased by the at least one first personal account exceeds the purchase limit, the user device correspondingly generates a warning signal to remind the user.

17. A method of automatically accounting, comprising:
a user device receives a purchase result; and
the user device operates an application to generate a user interface, and the user interface provides an account selection window according to the purchase result received;
wherein, the account selection window provides a plurality of first personal accounts for a user to select at least one first personal account so as to view a plurality of first purchase records of the at least one first personal account.

18. The method of automatically accounting according to claim 17, further comprising:
at least one POS terminal device generates a plurality of purchase signals;
the at least one POS terminal device transmits the purchase signals to a server according to a personal identity code;
the server processes the purchase signals received to generate the purchase result; and
the server transmits the purchase result after the user device establishes a network connection with the server.

19. An automated accounting system, comprising:
at least one POS terminal device, for generating a plurality of purchase signals;
a server, for receiving the purchase signals and generating a purchase result; and
a user device, for executing an application and receiving the purchase result to display a user interface, wherein the application is installed in the user device;
wherein, the user interface provides an account selection window according to the purchase result received, and the account selection window provides a plurality of first personal accounts for a user to select at least one first personal account so as to view a plurality of first purchase records of the at least one first personal account.
